(19) United States
(12) Patent Application Publication
(10) Pub. No.: US 2017/0248233 A1
(43) Pub. Date: Aug. 31, 2017

(54) GASKET AND DECELERATING CLUTCH APPARATUS OF A WASHING MACHINE

(71) Applicant: QINGDAO HAIER WASHING MACHINE CO., LTD., Qingdao, Shandong (CN)

(72) Inventors: Peishi LV, Qingdao, Shandong (CN); Lin YANG, Qingdao, Shandong (CN); Gangjin ZHANG, Qingdao, Shandong (CN); Shunji IMAI, Qingdao, Shandong (CN); Yuebin LIU, Qingdao, Shandong (CN); Yun TIAN, Qingdao, Shandong (CN)

(73) Assignee: QINGDAO HAIER WASHING MACHINE CO., LTD., Qingdao, Shandong (CN)

(21) Appl. No.: 15/514,677

(22) PCT Filed: Nov. 14, 2014
(86) PCT No.: PCT/CN2014/091150

§ 371 Date: Mar. 27, 2017

(30) Foreign Application Priority Data
Sep. 28, 2014 (CN) 201410508050.0

(51) Int. Cl. F16J 15/3268; D06F 37/40

(52) U.S. Cl. CPC F16J 15/3268; D06F 37/40

(57) ABSTRACT

A self-cleaning drum washing machine, comprises a coaxial drum and outer tub. Cleaning particles are arranged between the drum and the outer tub. Structures between the drum and the outer tub opposite to each other are smooth. A flange is fixedly connected to the bottom of the drum; the outer portion of the flange has a smooth structure or an enclosed cavity is arranged on the outer portion of the drum bottom; the flange is arranged in the cavity; a shaft hole is arranged at the center of the cavity; and a drum shaft sticks into the cavity through the shaft hole and is connected to the flange. The smooth structures go against the attachment of dirt, so that the outer wall of the drum and the inner wall of the outer tub can be conveniently cleaned by the cleaning particles.

### FIELD OF THE INVENTION

The present disclosure relates to the technical field of a washing machine sealing member, and more particularly, to a gasket and a decelerating clutch of a washing machine.

### BACKGROUND OF THE INVENTION

A dewatering shaft of a decelerating clutch apparatus of a present washing machine needs to be connected with an inner tub of the washing machine. A gasket is necessarily provided at a connection part of the dewatering shaft of the washing machine and the inner tub in order to fixedly install the inner tub onto the dewatering shaft and to ensure an installation height of the inner tub. There are usually two installing methods for existing gasket as following:

A method is using a commonly stainless steel gasket that is directly fitted on the dewatering shaft of the decelerating clutch. The structure of the dewatering shall of the decelerating clutch apparatus of the washing machine and the gasket without special structure as shown in FIG. 1 is very simple, and the gasket is just a regular stainless steel gasket or a simple combination of a stainless steel gasket and a rubber. A cross section of the dewatering shaft of the decelerating clutch apparatus is a circular. A positioning boss for preventing the gasket from sliding is provided on the lower part.

However, the gasket is easy to fall off during the manufacture or the transportation of the washing machine which causes a breakdown of the washing machine in the scheme described above. And a gap between a pulsator and the inner tub will go beyond a setting value, due to height of the inner tub lowed caused by the gasket fall off. And that will further cause the problem which clothes being damaged or pinched during a washing process.

Another method is shown in FIG. 2, FIG. 3, FIG. 4 and FIG. 5, the cross section of the dewatering shaft is a polygonal or a combination of polygonal and circular. A groove is designed on the dewatering shaft of the decelerating clutch apparatus which forms a limiting boss and the groove is a circular structure. The shape design of the gasket coincides with the shape of the cross section of the dewatering shaft, and the gasket is mounted on the dewatering shall and rotated to a certain angle so that the limiting boss at the dewatering shaft will block the gasket from falling off.

However, there are several problems in the scheme described above: firstly, the cross section of the dewatering shaft is a polygonal or a combination of polygonal and circular and this makes the processing of the dewatering shaft be more complex. Secondly, the, groove structure arranged on the dewatering shaft compromises the integrity of the dewatering shaft. The stress is easy to concentrate at the groove to cause the dewatering shaft to break and greatly reducing the overall strength of the dewatering shaft. Finally, the designed shape of the gasket matches the cross section of the dewatering shaft, which makes the processing of the gasket be more complex. And in order to achieve the gasket matching with the dewatering shaft, the requirements for the tolerance are also higher.

In brief, the above two methods can't make the dewatering shaft with the best strength while ensuring the stability of the gasket stability.

### SUMMARY OF THE INVENTION

In order to solve the technical problem described above, the present disclosure provides a gasket which can be applied to a decelerating clutch apparatus of a washing machine to solve a problem of the gasket easily falling off and also effectively avoid the problem that the strength of the dewatering shaft of the decelerating clutch apparatus is weakened due to structure design reasons.

In particular, the present invention adopts the following technical solutions:

A gasket comprises a metal ring body and/or a first elastic portion and a second elastic portion being made of an elastic material, the first elastic portion is provided on an inner side of the metal ring body, and the second elastic portion is provided on an outer side of the metal ring body and extends downward, the first elastic portion and the second elastic portion are respectively in an interference fit with a shaft which assembles with the first and second elastic portions.

Further, the first elastic portion is an elastic ring fixedly connected to an inner peripheral wall of the metal ring body, an upper end of the first elastic portion is higher than an upper end of the metal ring body, and a part of the first elastic portion is fixedly connected to an upper end of the metal ring body.

Further, an inner diameter of the first elastic portion gradually decreases from a lower end to an upper end.

Further, the second elastic portion is an elastic ring fixedly connected to an outer peripheral wall of the metal ring body, the second elastic portion extends toward the inner side and/or the outer side of the metal ring body, and a part of the second elastic portion is fixedly connected to the lower end of the metal ring body.

Further, a portion of the second elastic portion under the lower end of the metal ring body extends inwardly to form a fitting portion, the fitting portion has an interference fit with a shaft which it assembles with the fitting portion, an inner diameter of the Fitting portion gradually decreases from an upper end to a lower end.

Further, a portion of the second elastic portion under the lower end of the metal ring body extends outwardly to form a regulating portion, and a gap is between the regulating portion and the fitting portion.

Further, the fitting portion comprises a first inner curved portion, a first outer curved portion, and a first connecting portion for transitioning the first inner curved portion and the first outer curved portion, the first inner curved portion is bent toward the outer side of the metal ring body.

The regulating portion comprises a second inner curved portion, a second outer, curved portion and a second connecting portion for transitioning the second inner curved portion and the second outer curved portion.

The first outer curved portion and the second inner curved portion are spaced from each other to form a gap.

Another object of the present disclosure is to provide a decelerating clutch apparatus of a washing machine which applies with the gasket described above. The decelerating clutch comprises a dewatering shaft connected with an inner tub of the washing machine, the dewatering shaft is provided with a boss for preventing a gasket from falling off. The gasket is arranged onto the dewatering shaft, the first elastic portion is in interference fit with the dewatering shaft, and/or the second elastic portion is in interference fit with the boss.

Further, a cross section of the dewatering shaft is a circular, an outer diameter of a connection between the dewatering shaft and the boss is equal to an outer diameter of the dewatering shaft. The metal ring body, the first elastic portion and the second elastic portion of the gasket assembled onto the dewatering shaft are annular shape.

Further, a smallest inner diameter of the first elastic portion is smaller than the outer diameter of the dewatering shaft. The fitting portion of the second elastic portion is in interference fit with the boss, a smallest inner diameter of the fitting portion is smaller than an outer diameter of the boss.

The gasket of the present disclosure has a three-layer structure of the metal ring body and the first elastic portion, the second elastic portion made of an elastic material. In use, the, metal ring body is in clearance fit with a shaft with which the metal ring body assembles, and the first elastic portion and the second elastic portion respectively are in interference fit with the shaft with which the first, second elastic portions assembled, so that the gasket of the present disclosure can be mounted more reliably and is less likely to fall off.

The decelerating clutch apparatus of the washing machine of the present disclosure eliminates the groove for mounting the gasket onto the dewatering shaft on the basis of the present decelerating clutch apparatus of the washing machine. It enhances the strength of the dewatering shaft of the decelerating clutch apparatus of the washing machine and avoids the large deformation of the dewatering shaft during the high-speed dehydration process of the washing machine, which will cause a large vibration noise of the washing machine. And the cross section of the dewatering shaft of the decelerating clutch apparatus of the washing machine of the present disclosure is circular, of which manufacturing technology is simpler.

At the same time, the gasket of the present disclosure is employed in the decelerating clutch apparatus of the present disclosure, thus makes the gasket not easily fall off during the manufacture, maintenance and transportation of the washing machine. It prevents the occurrence of washing machine quality problems such as the pulsator being higher than the bottom of the inner drum, clothes being pinched, and foreign objects entering the machine.

### BRIEF DESCRIPTION OF THE DRAWINGS

FIG. 1 is a schematic diagram of a three-dimensional structure of a first existing gasket;

FIG. 2 is a schematic diagram of a three-dimensional structure of a second existing gasket;

FIG. 3 is a top view of the second existing gasket;

FIG. 4 is an assembly diagram of the second existing gasket mounted on a decelerating clutch apparatus of a washing machine;

FIG. 5 is a top view of the second existing gasket mounted on a decelerating clutch apparatus of a washing machine;

FIG. 6 is schematic diagram of a three-dimensional structure of a gasket of the present disclosure;

FIG. 7 is a section view of a gasket of the present disclosure;

FIG. 8 is a schematic diagram of a decelerating clutch apparatus of a washing machine of the present disclosure.

1—first elastic portion, 2—metal ring body, 3—second elastic portion, 4—fitting portion, 5—dewatering shaft, 6—pulsator shaft, 7—groove, 8—regulating portion, 9—gap, 10—boss, 41—first inner curved portion, 42—first connecting portion, 43—first outer curved portion, 81—second inner curved portion, 82—second connecting portion, 83—second outer curved portion

### DETAILED DESCRIPTION OF THE INVENTION

A gasket, and a decelerating clutch apparatus of a washing machine of the present disclosure are described in detail with reference to the accompanying drawings.

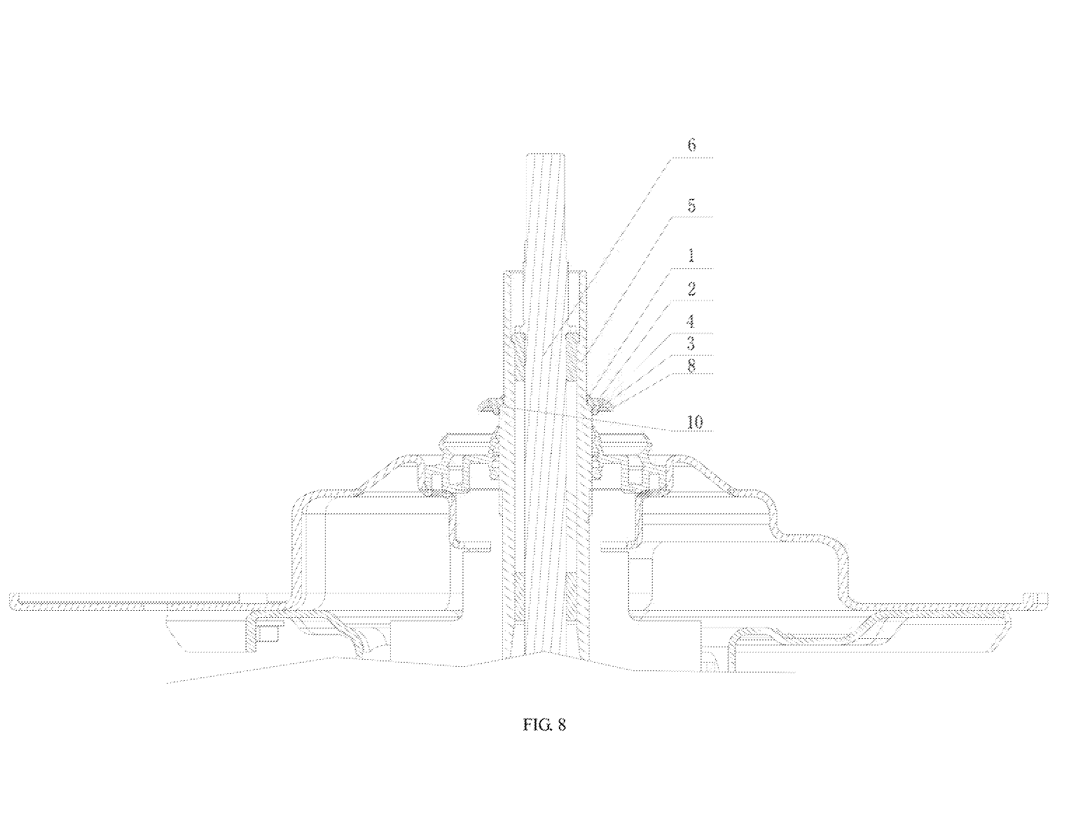

As shown in FIG. 6 and FIG. 7, a gasket of the present disclosure comprises a metal ring body 2 and/or a first elastic portion 1, a second elastic portion 3 made of an elastic material. The first elastic portion 1 is provided on an inner side of the metal ring body 2, and the second elastic portion 3 is provided on an outer side of the metal ring body 2 and extends downward. The metal ring body 2 is in clearance fit with a shaft which assembles with the metal ring body, the first elastic portion 1 and the second elastic portion 3 are respectively an interference fit with a shaft which assembles with them.

The metal ring body 2 of the present disclosure is made of stainless steel or other alloy material so as to ensure that the gasket as a whole has a certain strength, and the shape design of the metal ring body 2 forms the main integral structural shape of the gasket. In particular, the metal ring body 2 of the present disclosure can be designed in the form of circular hole, square hole, polygonal hole, or other shaped holes according to specific assembly requirements. In order to facilitate the installation of the gasket of the present disclosure, the metal ring body 2 of the present disclosure is in clearance fit with the shaft which assembles with the metal ring body. That is the inner diameter of the metal ring body 2 is larger than the outer diameter of the shaft.

The gasket of the present disclosure is provided with a first elastic portion 1 and a second elastic portion 3, respectively, on the inner and outer sides of the metal ring body 2. The first elastic portion 1 and the second elastic portion 3 are made of elastic material. In particular, it can be made of rubber material. Therefore, the first elastic portion 1, the second elastic portion 3 are respectively in interference fit with the shaft when the gasket of the present disclosure assembling with the shaft. It makes the assembled gasket of the present disclosure be more stable and not easy to fall off under the action of the first elastic portion 1 and the second elastic portion 2, which ensures the effectiveness of the gasket.

Therefore, the gasket of the present disclosure can be more easily mounted onto the dewatering shaft because the metal ring body 2 is in clearance fit with the shaft which assembles with the metal ring body. And after the installation of the gasket, the gasket of the present disclosure is not easy to get off due to the respectively interference fit between the first elastic portion 1, the second elastic portion 3 and the shaft. This ensures that it will not be lost during production or repair and prevent the occurrence of washing machine quality problems such as the agitator being higher than the bottom of the inner drum, clothes being pinched, and foreign objects entering the machine.

As a preferred embodiment of the present disclosure, the first elastic portion 1 is an elastic ring which is fixedly connected to an inner peripheral wall of the metal ring body 2. An upper end of the first elastic portion 1 is higher than an upper end of the metal ring, body 2, and a part of the first elastic portion 1 is fixedly connected to an upper end of the metal ring body 2.

Preferably, the first elastic portion 1 of the present disclosure is a rubber ring, the rubber ring is secured to the inner peripheral wall of the metal ring body 1. Therefore, the gasket of the present disclosure is provided with a rubber ring on the inner side of the metal ring body 2. Since the rubber ring has a certain degree of elasticity, it is possible to install the gasket of the present disclosure on the mounting shaft by applying a certain external force or other means at the time of installation. After the installation, the first elastic portion 1 is brought into close contact with the mounting shaft by the elastic force, the reliability of the gasket installation is ensured. The height of the first elastic portion 1 of the present disclosure is higher than that of the metal ring body 2 and the portion higher than the metal ring body 2 is fixedly connected to the upper end of the metal ring body 2. It can increase the contact area between the first elastic portion 1 and the metal ring body 2 and increase the fixation stability between the first elastic portion 1 and the metal ring body 2.

The height of the first elastic portion 1 of the present disclosure is higher the metal ring body 2, the inner diameter of the first elastic portion 1 gradually decreases from the lower end to the upper end. And the first elastic portion 1 is a trumpet mouth shape of which the inner diameter is smaller at upper portion and larger at lower portion. The advantageous is that it is easy to install at the time of installation and is not easily removed after installation, thereby ensuring the stability of the gasket mounting of the present disclosure.

As a preferred embodiment of the present disclosure, the second elastic portion 3 is an elastic ring fixedly connected to the outer peripheral wall of the metal ring body 2. The second elastic portion extends toward the inner side and/or the outer side of the metal ring body 3, a portion of the second elastic portion 3 is fixedly connected with the lower end of the metal ring body 2.

Preferably, the second elastic portion 3 is also a rubber ring and the rubber ring is fixed to an outer wall of the metal ring body 1. Therefore, the gasket of the present disclosure is provided with a downwardly extending, rubber ring on the outer side of the metal ring body 2, Since the rubber ring has a certain degree of elasticity, it is possible to install the gasket of the present disclosure on the mounting shaft by applying a certain external force or other means at the time of installation. After the installation, the second elastic portion 3 is brought into close contact with the mounting shaft by the elastic force, the reliability of the gasket installation is ensured. The second elastic portion 3 of the present disclosure extends to the lower portion of the metal ring body 2 and the extended portion is fixedly connected to the lower end of the metal ring body 2. It can increase the contact area between the second elastic portion 3 and the metal ring body 2 and increase the fixation stability between the second elastic portion 3 and the metal ring body 2.

As a preferred embodiment of the present disclosure, a portion of the second elastic portion 3 under the lower end of the metal ring body 2 extends inwardly to form a fitting portion 4. The fitting portion 4 has an interference fit with a shaft which assembles the fitting portion, an inner diameter of the fitting portion 4 gradually decreases from an upper end to a lower end.

An inner diameter of the fitting portion 4 of the present disclosure decreases from the upper end to the lower end. This makes the fitting portion 4 of the second elastic portion 3 is a trumpet mouth shape in which the inner diameter is smaller at upper portion and larger at lower portion. The advantageous is that it is easy to install and is not easily removed after installation, further increase the stability of the gasket mounting of the present disclosure.

As a preferred embodiment of the present disclosure, a portion of the second elastic portion 3 under the lower end of the metal ring body 2 extends outwardly to form a regulating portion 8, and a gap 9 is between the regulating portion 8 and the fitting portion 4.

The second elastic portion 3 of the present disclosure comprises the fitting portion 4 and the regulating portion 8, the fitting portion 4 extends inwardly to realize an interference fit with the mounting shaft to ensure the stability of the gasket mounting. A gap 9 is formed between the regulating portion 8 extending outwardly and the fitting portion 4. In this way, the fitting portion 4 has a certain elasticity and is able to extend to, the gap 9 on the outer side so that the fitting portion 4 has a fine adjustment. Thus, the mounting shaft mounted by the gasket of the present disclosure has a greater radial length range.

As a preferred embodiment of the present disclosure, a middle of the lower end of the second elastic portion 3 is recessed inward to form an annular gap, and the second elastic portion 3 is divided into a fitting portion 4 and a regulating portion 8 by the annular gap. The fitting portion 4 comprises a first inner curved portion 41, a first outer curved portion 43, and a first connecting portion 42 for transitioning the first inner curved portion 41 and the first outer curved portion 43. One end of the first inner curved portion 41 is connected to the lower end portion of the metal ring body 2, the other end extends toward the inner side of the metal ring body 2. Thus it makes the first inner curved portion 41 and the boss at lower portion have an interference fit with each other, and the inner diameter of the first inner curved portion 41 gradually decreases from the upper portion to the lower portion. The regulating portion 8 comprises a second inner curved portion 81, a second outer curved portion 83 and a second connecting portion 82 for transitioning the second inner curved portion 81 and the second outer curved portion 83. One end of the second outer curved portion 83 is connected to the side wall of the metal ring body 3, the other end extends toward the outer side of the metal ring body 2. The gap 9 is provided between the first outer curved, portion 43 and the second inner curved portion 81.

This arrangement is mainly to have a smooth transition between the fitting portion 4 and the regulating portion 8 to form a gap 9, which is more advantageous for dispersing the force, preventing stress concentration and improving the service life of the gasket.

As shown in FIG. 8 a decelerating clutch apparatus of the washing machine which is applied with the gasket described above, comprises a dewatering shaft 5, the dewatering shaft 5 is connected to the inner tub of the washing machine. The gasket is provided on the connection of the dewatering shaft 5 and the inner tub, a boss 10 for preventing the gasket from falling off is provided on the dewatering shaft 5.

As a preferred embodiment of the present disclosure, the first elastic portion 1 of the gasket has an interference fit with the dewatering shaft 5, the second elastic portion 3 has an interference fit with the boss 10. The radial length of the inner ring of the metal ring body 2 is larger than the radial length of the dewatering shaft 5 and is smaller than the radial length of the boss 10. So the metal ring body 2 of the gasket of the present disclosure does not fall off under the blocking action of the boss 10. The interference fit between the first elastic portion 1 and the dewatering shaft 5 and the interference fit between the second elastic portion 3 and the boss 10 ensure that the gasket mounted onto the dewatering shaft does not rotate. Therefore, the gasket of the present disclosure is more stable and less likely to be disengaged after being mounted on the dewatering shaft of the deceleration clutch apparatus. It ensures that it is not be lost during production or repair and prevent the occurrence of washing machine quality problems such as the pulsator being higher than the bottom of the inner drum, clothes being pinched, and foreign objects entering the machine.

As a preferred embodiment of the present disclosure, the cross section of the dewatering shaft 5 is a circular, an outer diameter of a connection between the dewatering shaft 5 and the boss 10 is equal to an outer diameter of the dewatering shaft 5. The metal ring body 2 of the gasket assembled onto the dewatering shaft 5, the first elastic portion 1 and the second elastic portion 3 are annular shape.

The dewatering shaft 5 of the present disclosure is made into a simple cylindrical shape and does not need to be made into a polygonal structure or a composite structure with a polygonal and circular, and it greatly simplifies the manufacturing process of the dewatering shaft 5, reduces the cost. And the metal ring body 2, the first elastic portion 1 and the second elastic portion 3 of the gasket are made as an annular shape corresponding to the shape of the dewatering shaft. The structure is more simple, the manufacturing process has been simplified, manufacturing costs have been reduced, with good prospects for marketing.

In addition, the outer diameter of the connection between the dewatering shaft 5 and the boss 10 is equal to the outer diameter of the dewatering shaft 5 in the present disclosure. That is, the dewatering shaft 5 of the present disclosure is not provided with a groove structure so that the stress concentration due to the provision of the groove structure does not occur, and the structural strength of the dewatering shaft 5 is greatly increased.

As a preferred embodiment of the present disclosure, the smallest inner diameter of the first elastic portion 1 is smaller than the outer diameter of the dewatering shaft 5. The fitting portion 4 of the second elastic portion 3 has an interference fit with the boss 10, the smallest inner diameter of the fitting portion 4 is smaller than the outer diameter of the boss 10.

The decelerating clutch apparatus of the present disclosure has, the following advantages:

First, the dewatering shaft 5 of the decelerating clutch apparatus is made into a simple cylindrical shape and the structure is more simple, the manufacturing process is more simplified, the manufacturing cost is reduced.

Secondly, the dewatering shaft 5 of the decelerating clutch apparatus is not provided with a groove structure so that the breakage appearance of the dewatering shaft is avoided due to the stress concentration in the groove, and the structural strength of the dewatering shaft 5 is greatly increased. And the processing technology has also been a corresponding simplified.

Finally, the gasket of the decelerating clutch apparatus of the present disclosure does not fall off or rotate after mounting onto the dewatering shaft 5. Therefore, the gasket mounting of the decelerating clutch apparatus of the present disclosure is more stable and reliable.

### Embodiment 1

As shown in FIG. 1, the existing gasket is a simple circular metal ring and the gasket is mounted on the decelerating clutch apparatus of the washing machine without no special structure for positioning. Therefore, during the manufacture, maintenance or transportation, the gasket is easy to fall off and cause a breakdown of the washing machine. And, a gap between a pulsator and the inner tub is beyond a setting value due to height of the inner tub lowed caused by the gasket fall off. And that further causes the problem which clothes being damaged or pinched during a washing process.

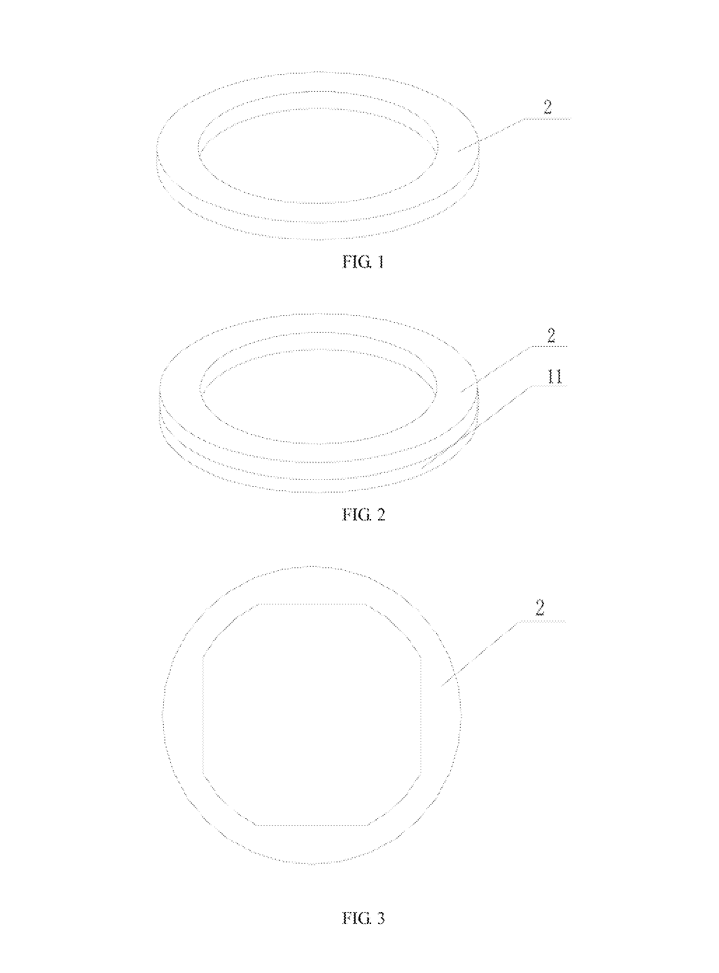

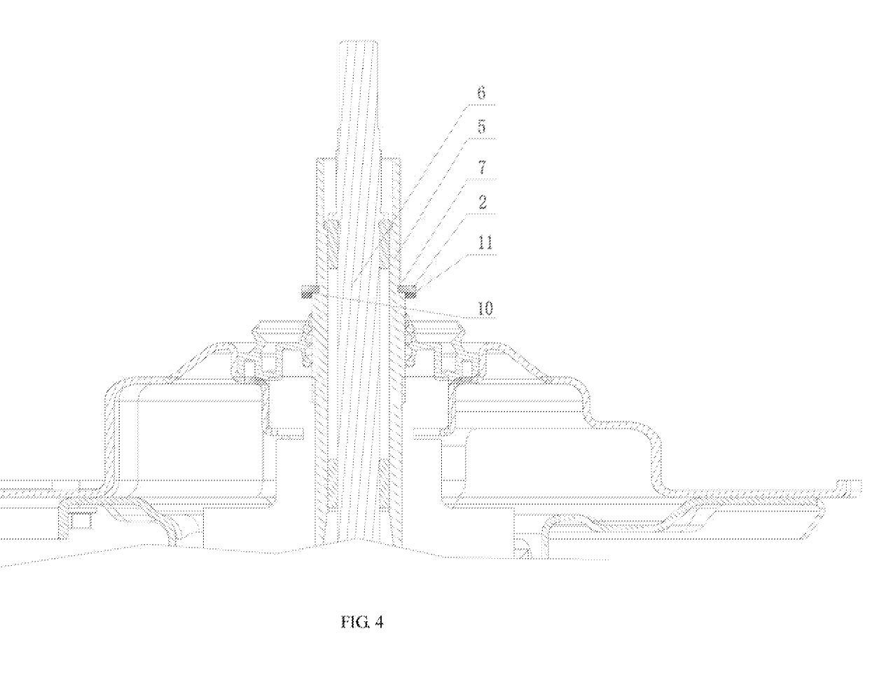

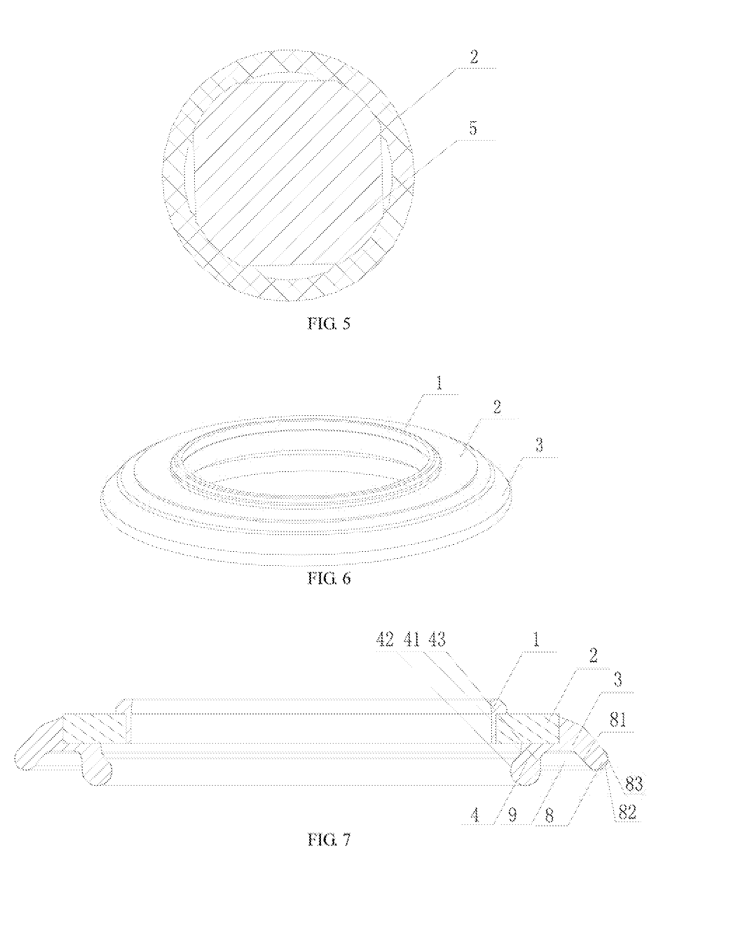

As shown in FIG. 2, FIG. 3, FIG. 4 and FIG. 5, another existing gasket and a decelerating clutch apparatus of a washing machine using the gasket, the gasket comprises a metal ring body 2 and a rubber ring 11 fixedly connected to the lower end of the metal ring body 2. As shown in FIG. 4, the decelerating clutch apparatus of the washing machine using the gasket described above includes a dewatering shaft 5. The cross section of the dewatering shaft 5 and the shape of the opening of the metal ring body 2 of the gasket are shown in FIG. 5, both of which are in the form of a combination of a circle and a square. The lower portion of the dewatering shaft 5 is provided with a boss 10, and a circular groove 7 is arranged at the connection between the dewatering shaft 5 and the boss 10. The opening design of the metal ring body 2 of the gasket coincides with the cross section of the dewatering shaft 5. The gasket is mounted to the dewatering shaft 5 and then rotated to a certain angle at the groove 7 so that the axial displacement of the gasket is restricted by the action of the boss 10 and the groove 7 of the dewatering shaft 5.

However, the above-mentioned prior art has the following problems: First, the cross section of the dewatering shaft 5 is polygonal or polygonal and circular in combination so that the processing of the dewatering shaft 5 is more complicated. Next, the groove 7 is provided on the dewatering shaft 5, which compromises the integrity of the dewatering shaft 5 and tends to cause stress concentration at the groove 7 to cause the dewatering shaft 5 to break and greatly reduce the overall strength of the dewatering shaft 5. Finally, the shape design of the gasket coincides with the cross section of the dewatering shaft 5, the processing of the gasket is more complicated, and the tolerance requirements are higher, so that the gasket can be matched with the dewatering shaft.

As shown in FIG. 6 and FIG. 7, a gasket of the present embodiment comprises a circular-shaped metal ring body 2, a first, elastic portion 1 made of a rubber material is fixed to the inner side of the metal ring body 2 and a second elastic portion 2 made of a rubber material is fixed to the outer side of the metal ring body 2.

The first elastic portion 1 is inclined upwardly and the inner diameter gradually decreases from the lower end to the upper end.

The second elastic portion 3 is inclined downwardly, and includes a fitting portion 4 and a regulating portion 8. The fitting portion 4 is a portion of the second elastic portion 3 extending toward the inner side of the metal ring body 2. The regulating portion 8 is a portion of the second elastic portion 3 extending toward the outer side of the metal ring body 2. And a gap 9 between the fitting portion 4 and the regulating portion 8 is provided.

As shown in FIG. 8, the decelerating clutch apparatus of the present disclosure comprises as dewatering shaft 5, inside the dewatering shaft 5 is provided with a pulsator shaft 6 coaxially. The dewatering shaft is connected to the inner tub of the washing machine. The gasket of the present disclosure is mounted onto the dewatering shaft 5 and at the connection position with the inner tub of the washing machine, and is mainly under the lower portion of the inner tub of the washing machine, which makes the inner tub of the washing machine have a certain mounting height. It achieves the assembly relationship between the inner tub of the washing machine and the pulsator of the washing machine. The lower portion of the dewatering shaft 5 is provided with a boss 10 whose outer diameter is larger than the outer diameter of the dewatering shaft 5, and the boss 10 mainly prevents the gasket from falling off.

The cross section of the dewatering shaft 5 of the present embodiment is circular, and the connection between the dewatering shaft 5 and the boss 10 is not provided with a groove.

The decelerating clutch apparatus of the embodiment has the following advantages:

First, the dewatering shaft 5 of the decelerating clutch apparatus is designed into a simple cylindrical shape and the structure is more simple, the manufacturing process is more simplified, the manufacturing cost is reduced.

Secondly, the dewatering shaft 5 of the decelerating clutch apparatus is not provided with a groove 7 so that the breakage appearance of the dewatering shaft is avoided due to the stress concentration in the groove 7 and the structural strength of the dewatering shaft 5 is greatly increased. And the processing technology has also been a corresponding simplified.

Finally, the gasket of the decelerating clutch apparatus does not fall off or rotate after mounting onto the dewatering shaft 5. Therefore, the gasket mounting of the decelerating clutch apparatus is more stable and reliable.

The foregoing is only a preferred embodiment of the present disclosure and is not intended to be limiting of the present disclosure. While the present invention has been described above with reference to preferred embodiments, it is not intended to limit the disclosure. Any person skilled in the art will, without departing from the scope of the technical solution of the present disclosure, may make use of the technical contents of the above-mentioned schemes to make some modifications or modifications equivalent to equivalent variations. Any simple modifications, equivalents, and modifications of the foregoing embodiments are within the scope of the present disclosure without departing from the spirit of the technical solution of the present disclosure in accordance with the technical details of the present disclosure.

1. A gasket, wherein, the gasket comprises a metal ring body, and a first elastic portion and a second elastic portion being made of an elastic material,
the first elastic portion is provided on an inner side of the metal ring body, and the second elastic portion is provided on an outer side of the metal ring body and extends downward,
the first elastic portion and the second elastic portion are respectively in an interference fit with a shaft which assembles with the first and second elastic portions.

2. The gasket according to claim 1, wherein, the first elastic portion is an elastic ring fixedly connected to an inner peripheral wall of the metal ring body, an upper end of the first elastic portion is higher than an upper end of the metal ring body, and a part of the first elastic portion is fixedly connected to an upper end of the metal ring body.

3. The gasket according to claim 1, wherein, an inner diameter of the first elastic portion gradually decreases from a lower end to an upper end.

4. The gasket according to claim 1, wherein, the second elastic portion is an elastic ring fixedly connected to an outer peripheral wall of the metal ring body, the second elastic portion extends toward the inner side and/or the outer side of the metal ring body, and a part of the second elastic portion is fixedly connected to a lower end of the metal ring body.

5. The gasket according to claim 1, wherein, a portion of the second elastic portion under a lower end of the metal ring body extends inwardly to form a fitting portion, the fitting portion has an interference fit with a shaft which it assembles with the fitting portion, an inner diameter of the fitting portion gradually decreases from an upper end to a lower end.

6. The gasket according to claim 5, wherein, the portion of the second elastic portion under the lower end of the metal ring body extends outwardly to form a regulating portion, and a gap is between the regulating portion and the fitting portion.

7. The gasket according to claim 6, wherein, the fitting portion comprises a first inner curved portion, a first outer curved portion, and a first connecting portion for transitioning the first inner curved portion and the first outer curved portion, the first inner curved portion is bent toward the outer side of the metal ring body;
the regulating portion comprises a second inner curved portion, a second outer curved portion and a second connecting portion for transitioning the second inner curved portion and the second outer curved portion;
the first outer curved portion and the second inner curved portion are spaced from each other to form the gap.

8. A decelerating clutch apparatus of a washing machine applying the gasket according to claim 1, comprising a dewatering shaft connected with an inner tub of the washing machine, the dewatering shaft is provided with a boss for preventing the gasket from falling off;
wherein, the gasket is arranged onto the dewatering shaft, the first elastic portion is in interference fit with the dewatering shaft, and/or the second elastic portion is in interference fit with the boss.

9. The decelerating clutch apparatus of the washing machine according to claim 8, wherein, a cross section of the dewatering shaft is a circular, an outer diameter of a connection between the dewatering shaft and the boss is equal to an outer diameter of the dewatering shaft,
the metal ring body, the first elastic portion and the second elastic portion of the gasket assembled onto the dewatering shaft are annular shape.

10. The decelerating clutch apparatus of the washing machine according to claim 9, wherein, a smallest inner diameter of the first elastic portion is smaller than the outer diameter of the dewatering shaft,
the fitting portion of the second elastic portion is in interference fit with the boss, a smallest inner diameter of the fitting portion is smaller than an outer diameter of the boss.

11. The gasket according to claim 2, wherein, an inner diameter of the first elastic portion gradually decreases from a lower end to an upper end.

12. The gasket according to claim 2, wherein, a portion of the second elastic portion under the lower end of the metal ring body extends inwardly to form a fitting portion, the fitting portion has an interference fit with a shaft which it assembles with the fitting portion, an inner diameter of the fitting portion gradually decreases from an upper end to a lower end.

13. The gasket according to claim 4, wherein, a portion of the second elastic portion under the lower end of the metal ring body extends inwardly to form a fitting portion, the fitting portion has an interference fit with a shaft which it assembles with the fitting portion, an inner diameter of the fitting portion gradually decreases from an upper end to a lower end.
